(19) United States
(12) Patent Application Publication
(10) Pub. No.: US 2013/0173332 A1
(43) Pub. Date: Jul. 4, 2013

(54) ARCHITECTURE FOR ROOT CAUSE ANALYSIS, PREDICTION, AND MODELING AND METHODS THEREFOR

(71) Applicants: Tom Thuy Ho, San Carlos, CA (US); Weidong Wang, Union City, CA (US); Woon-Kyu Choi, Seoul (KR); Ji-Hoon Keith Han, Seoul (KR); Gabriel Serge Villareal, Fresno, CA (US)

(72) Inventors: Tom Thuy Ho, San Carlos, CA (US); Weidong Wang, Union City, CA (US); Woon-Kyu Choi, Seoul (KR); Ji-Hoon Keith Han, Seoul (KR); Gabriel Serge Villareal, Fresno, CA (US)

(21) Appl. No.: 13/340,574

(22) Filed: Dec. 29, 2011

(51) Int. Cl. G06Q 10/06

(52) U.S. Cl. 705/7.27

(57) ABSTRACT

Systems and methods for automatically and/or systematically include more data sources and/or more detailed data in the analysis, prediction, and model building. Process data may be employed to pinpoint the process parameter excursions and domain knowledge and/or expert systems may be automatically and/or systematically incorporated into the root cause analysis, the prediction and/or the model building to improve results and/or to reduce the reliance on inconsistent and expensive human experts.

### PRIORITY CLAIM

The present application is a continuation in part under 35 USC 120 to a commonly assigned, previously filed patent application entitled “ARCHITECTURE FOR ANALYSIS AND PREDICTION OF INTEGRATED TOOL-RELATED AND MATERIAL-RELATED DATA AND METHODS THEREFOR”. Application Ser. No. 13/192,387, filed on Jul. 27, 2011, by the same inventors herein, which is incorporated herein by reference.

### BACKGROUND OF THE INVENTION

Equipment Engineering System (EES) systems have long been employed to record tool-related data (e.g., pressure, temperature, RF power, process step ID, etc.) in a typical semiconductor processing equipment. To facilitate discussion, FIG. 1A shows a prior art Equipment Engineering System (EES) system 102, which focuses on the semiconductor processing tools (e.g., semiconductor processing systems and chambers) and collects data from tools 104-110. Tools 104-110 may represent etchers, chemical mechanical polishers, deposition machines, etc. The data collected by EES system 102 may represent process parameters such as process temperature, process pressure, gas flow, power consumption, process event data (start, end, step number, wafer movement data, etc.), and the like. EES system 102 may then process the data collected to generate alarm 122 (based on high/low limits, for example), to generate control command 120 (e.g., to start or stop the tool), and to produce analysis results (e.g., charts, tables, and the like).

Yield Management System (YMS) systems have also long been employed to record material-related data (e.g., post-process critical dimension measurements, etch depth measurements, electrical parameter measurements, etc.) on post-processing wafers. FIG. 1B shows a prior art Yield Management System (YMS) 152, which focuses on the wafers and collects data from wafers 154-160. The data collected by YMS system 152 from the wafers may include metrology data (thickness, critical dimensions, number of defects on wafers), electrical measurements that measure electrical behavior of devices, yield data, and the like. The data may be collected at the conclusion of a process step or when wafer processing is completed for a given wafer or a batch of wafers, for example. YMS system 152 may then process the data collected to generate analysis results, which may be presented as chart 160 or result table 162, for example.

Since YMS 152 focuses on yield-related data, e.g., measurement data from the wafers, YMS 152 is capable of ascertaining, from the wafers analyzed, which tool may cause a yield problem. For example, YMS 152 may be able to ascertain from the metrology data and the electrical parameter measurements that tool 42 has been producing wafers with poor yield. However, since YMS 152 does not focus on or collect significant and detailed tool-related data, it is not possible for YMS system 152 to ascertain the conditions and/or settings (e.g., the specific chamber pressure during a given etch step) on the tool that may cause the yield-related problem. Further, as an example, lacking access to the data regarding the tool conditions/settings, it is not possible for YMS 152 to perform analysis to ascertain the common tool conditions/settings (e.g., chamber pressure or bias power setting) that exist when the poor yield processing occurs on one or more batches of wafers. Conversely, since EES 102 focuses on tool-related data, EES 102 may know about the chamber conditions and settings that exist at any given time but may not be able to ascertain the yield-related results from such conditions or settings.

In the prior art, a process engineer, upon seeing the poor process results generated by YMS 152, typically needs to access other tools (such as EES 102) to obtain tool-related data. By painstakingly correlating YMS data pertaining to low wafer yield to data obtained from tools (e.g., EES data), the engineer may, with sufficient experience and skills, be able to ascertain the parameter(s) and/or sub-step of the process(es) that cause the low wafer yield.

However, this approach requires highly skilled experts performing painstaking, time-consuming data correlating between the YMS data from the YMS system and the EES data from the EES system and painstaking, time-consuming analysis (e.g., weeks or months in some cases) and even if such experts can successfully correlate manually the two (or more) independent systems and detect the root cause of the yield-related problem, the prior art process is still time consuming and incapable of being leveraged for timely automatic analysis of cause/effect data to facilitate problem detection and/or alarm generation, and/or tool control and/or prediction with a high degree of data granularity.

Another drawback from the highly manual and non-integrated usage of data in the prior art relates to the fact that data mining on based strictly or predominantly on YMS data (e.g., material-related and yield-related data) as well as tracking WIP data (work-in-progress tracking data such as which equipment was involved, time, operator, etc.) to perform root cause analysis often results in inaccurate determinations of root causes of process faults. This is because data from other sources, as well as more accurate approaches based on statistics and/or experts and/or domain knowledge, are not well-integrated into the root cause analysis. The same could be said for processes for prediction (such as prediction of when maintenance may be required) or for building, models to achieve the same.

What is desired, therefore, is a more unified and comprehensive approach to systemize the use of various data sources and techniques based on statistics and/or experts and/or domain knowledge to obtain more accurate root cause analysis, prediction and/or models.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a prior art Equipment Engineering System (EES) system, which focuses on the semiconductor processing tools.

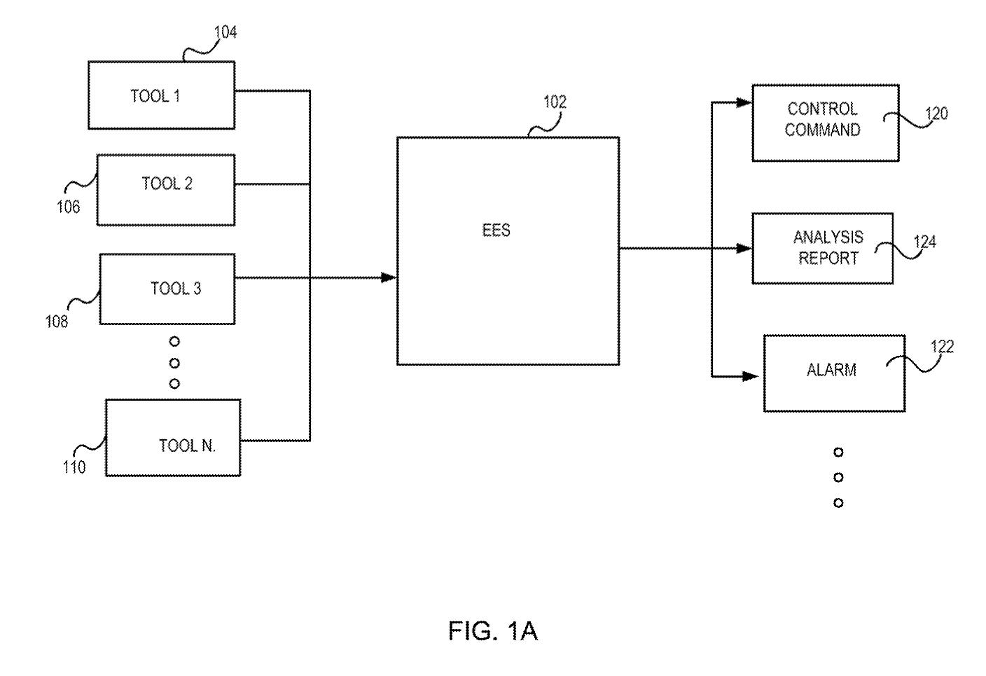

FIG. 1B shows a prior art Yield Management System (YMS), which focuses on the wafers and collects data from wafers.

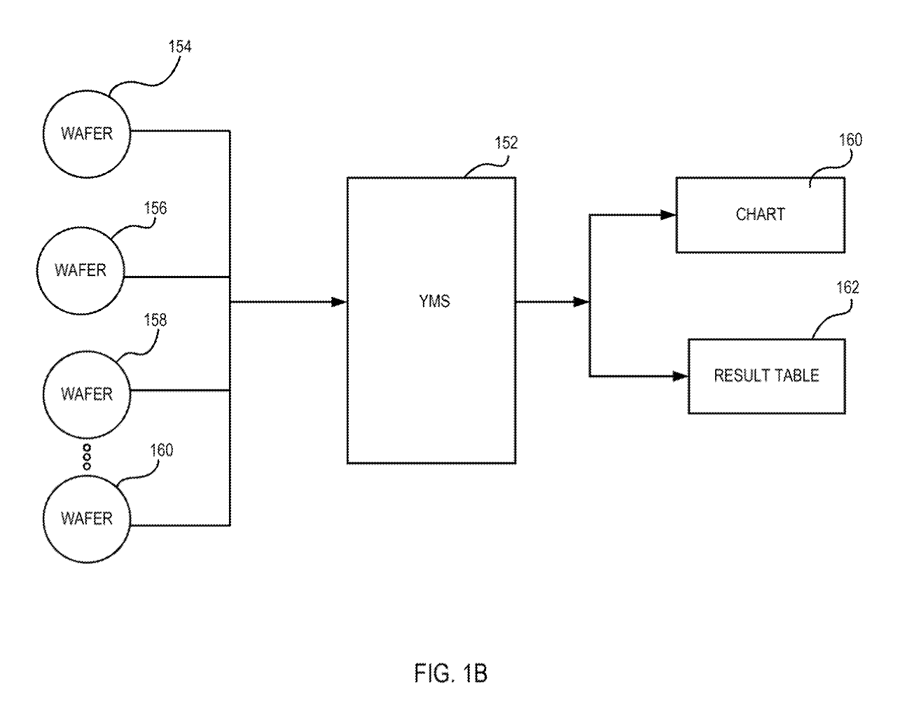

FIG. 2 shows, in accordance with an embodiment of the invention, a YiEES (Yield Intelligence Equipment Engineering System), which collects tool-related data from THE tools as well as wafer-related data from wafers and implements an integrated analysis and prediction platform based on the integrated data.

FIG. 3 shows, in accordance with an embodiment of the invention, a more detailed view of a YiEES system,

FIG. 4 shows the implementation of an example online control/optimization module that is analogous to the plug-and-play modules discussed in connection with the online control/analysis layer of FIG. 3.

FIG. 5 illustrates, in accordance with an embodiment of the invention, the improved analysis technique with pre-filtering via classification/clustering and/or using different analysis methodologies and/or different statistical techniques.

FIG. 6 illustrates, in accordance with an embodiment of the present invention, a flow diagram for systemizing and improving the results of root cause analysis, prediction, and model building.

FIG. 7 shows, in accordance with an embodiment of the present invention, detailed steps implementing the root cause analysis to produce the root cause result.

FIG. 8 illustrates, in accordance with an embodiment of the invention, the model building process.

FIG. 9 shows, in accordance with an embodiment of the present invention, an implementation of the prediction process.

FIG. 10 shows, in accordance with an embodiment of the invention, some example constituent data in the knowledge base.

FIG. 11 illustrates, in accordance with an embodiment of the invention, associating main and related effects, which are employed for root cause analysis or prediction.

FIG. 12 shows the steps for selecting predictor variable or causal variable.

FIG. 13 shows, in accordance with an embodiment of the invention, the implementation of the analysis step.

FIG. 14 shows the use of process flow data to improve the analysis, prediction or modeling.

FIG. 15 shows, the hierarchical organizing of effect data and causal/prediction data in order to more appropriately apply the appropriate statistical/analysis techniques to obtain improved root cause analysis, prediction, and/or models.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Embodiments of the invention relate to systems for integrating both cause data (tool-related, or process-related data) and effect data (material-related or material-related data) on a single platform. In one or more embodiments, an integrated yield/equipment data processing system for collecting and analyzing integrated tool-related data and material-related data pertaining to at least one wafer processing tool and at least one wafer is disclosed. By integrating, cause-and-effect data in a single platform, the data necessary for automated problem detection (e.g., automated root cause analysis) and prediction is readily available and correlated, which shortens the cycle time to detection and facilitates efficient and timely automated tool management and control,

As the term is employed herein, the synonymous term “automatic”, “automatically” or “automated” (e.g., automated root cause analysis, automated problem detection, automated model building, etc.) denotes, in one or more embodiments, that the action (e.g., analysis, detection, optimization, model building, etc.) occur automatically without human intervention as tool-related and material-related data are received, correlated, and analyzed by logic (software and/or hardware), in one or more embodiments, prior human input (in the form of domain knowledge, expert knowledge, rules, etc.) may be pre-stored and employed in the automated action, but the action that results (e.g., analysis, detection, optimization, model building, etc.) does not need to wait for human intervention to occur after the relevant tool-related and material-related data are received. In one or more embodiments, minor human intervention (such as issuing the start command) may be involved and is also considered part of the automated action but on the whole, all the tool-related and material-related data as well as models, rules, algorithms, logic, etc. to execute the action (e.g., analysis, detection, optimization, model building, etc.) are available and the action does not require substantive input by the human operator to occur.

As the term is employed herein, a knowledge base is a storage area designed specifically for storing, classifying, indexing, updating, and searching domain knowledge and case study results (or historical results). It may contain tool and process profiles, models for prediction, analysis, control and optimization. The content in the knowledge base can be input and updated manually or automatically using the YiEES system. It is used as prior knowledge by YiEES system for model building, analysis, tool and process control and optimization.

For example, one or more embodiments of the invention integrate both cause and effect data on a single platform to facilitate automatic, analysis using computer-implemented algorithms that automatically detect material-related problems and pin-point the tool-related data (such as a specific pressure reading on a specific tool) that causes such material-related problems and/or build prediction models for better process control identify optimal process condition, provide prediction for timely machine maintenance, etc. Once the root cause is determined/or an model is built and traced to a specific tool and/or step in the process, automated tool control may be initiated to correct the problem or set the process to its optimal condition, for example.

In this manner, the time-consuming aspect of manual data correlation and analysis of the prior art is substantially eliminated. Further, by removing the need for human data correlation and analysis, human-related errors can be substantially reduced. Root cause analysis may now be substantially automated, which reduces error and improves speed.

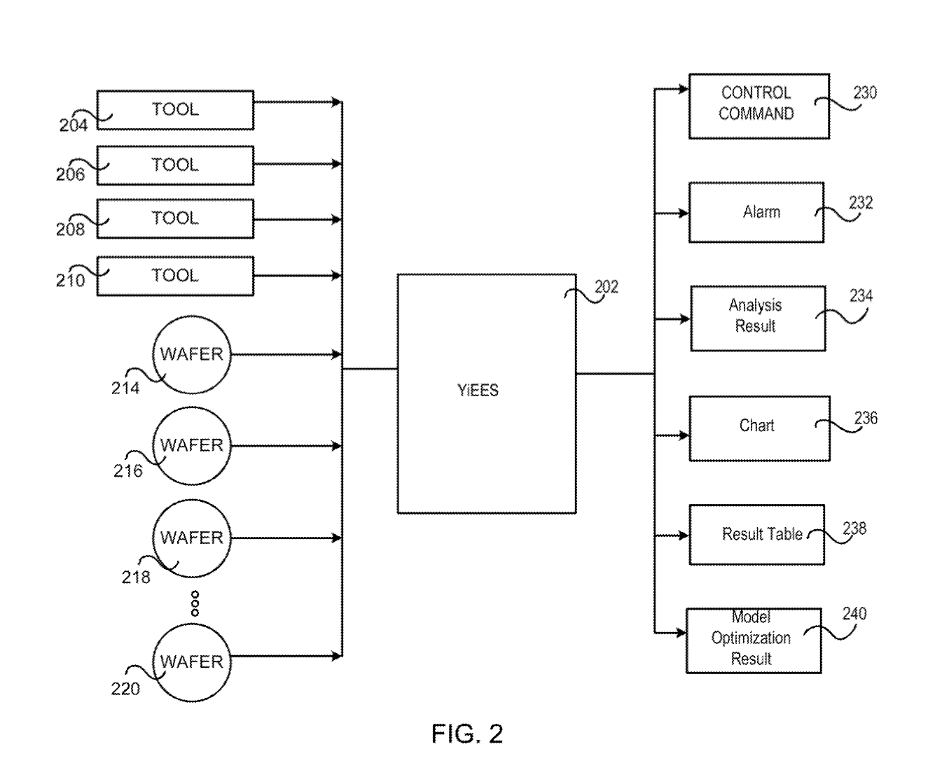

The features and advantages of embodiments of the invention may be better understood with reference, to the figures and discussions that follow. FIG. 2 shows, in accordance with an embodiment of the invention, a YiEES (Yield Intelligence Equipment Engineering System) 202, representing art implementation of the aforementioned integrated yield/equipment data processing system, which collects tool-related data from tools 204-210 as well as wafer-related data from wafers 214-220. The tool and wafer data is then input into YiEES 202, which performs automated analysis or model optimization based on both the effect data (e.g., wafer-related measurements made on the wafers) and the cause data (e,g., tool parameters or process step data). The result of the automated analysis and/or model optimization may then be employed for automated tool command and control. 230, alarm generation 232, analysis result generation 234, model optimization result 240, chart generation 236, and/or result table generation 238.

The material-related data from tools 214-220 may be collected using an appropriate I/O module or I/O modules and may include, for example, wafer ID or material ID, wafer history data or material history data, which contains the date/time information, the process step ID, the tool ID, the processing recipe ID, and any material-related quality measurements such as any physical measurements, for example film thickness, film resistivity, critical dimension, defect data, and any electrical measurements, for example transistor threshold voltage, transistor saturation current (IDSAT), or any equivalent material-related quality measurements. The tool-related data from tools 204-210 may be collected using an appropriate I/O module or I/O modules and may include, for example, the date/time information, the tool ID, the processing recipe ID, subsystems and tool component historical data, and any other process-related measurements, for example pressure, temperature, gas flows

In one or more embodiments, the date/time, tool ID and optionally recipe ID, may be employed as common attributes or correlation keys to align or correlate, using appropriate logic (which may be implemented via dedicated logic or as software executed in a programmable logic/processor for example) the tool-related data with the material-related data (for example, tool-related parameter values with metrology measurement values on specific materials (i.e., wafers), thereby permitting a computer-implemented algorithm to correctly correlate and perform the automated analysis on the combined material-related data and tool-related data.

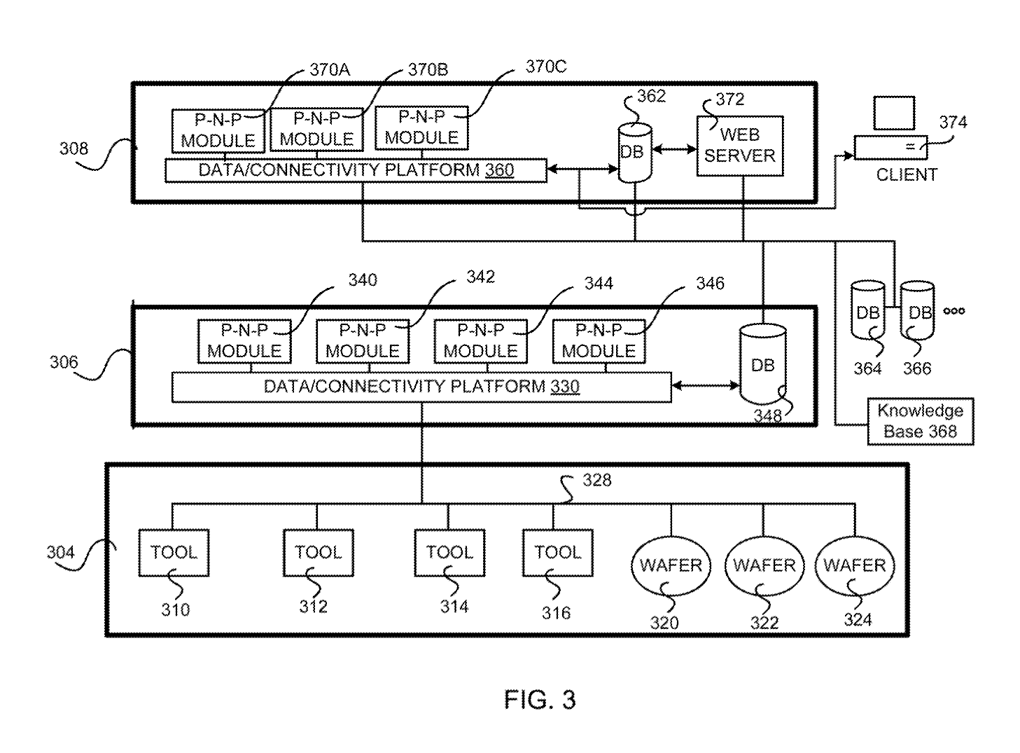

FIG. 3 shows, in accordance with an embodiment of the invention, a more detailed view of a YiEES system. With respect to FIG. 3, YiEES system 302 includes 3 conceptual layers: data layer 304, online control/analysis layer 306, and offline analysis layer 308. Data layer 304 represents layer wherein the tools (310-316) and/or wafers (320-324) conceptually reside and from which tool-related and material-related data may he obtained via appropriate I/O modules. In general terms, the tool-related data may be thought of as cause data for the automated analysis, and material-related data may be thought of as effect data for the automated analysis. As can be seen in FIG. 3, both the cause and effect data are present in a single platform, collected and sent to online/analysis layer 306 via bus 328.

Online control/analysis layer 306 represents the layer that contains the plug-and-play modules for performing automated control, optimization, analysis, and/or prediction based on the integrated tool-related and material-related data collected from data layer 304. To facilitate plug-and-play modules for online control/analysis, a data/connectivity platform 330 serves to interface with bus 328 to obtain tool-related and material-related data from data layer 304 as well as to present a standard interface to communicate with the plug-and-play modules. For example, data/connectivity platform 330 may implement APIs (application programming interfaces) with pre-defined connectivity and communication options for the plug-and-play modules.

Plug-and-play modules 340, 342, 344, 346 represent 4 plug-and-play modules to, for example, perform the automated control (SPC, MPC, APC), tool profiling, process profiling, tool optimization, processing optimization, modeling building, dynamic model update and modification, analysis, and/or prediction using the integrated tool-related and material-related data collected from data layer 304. The plug-and-play modules may be implemented via dedicated logic or as software executed in a programmable logic/processor, for example. Each of plug-and-play modules 340, 342, 344, 346 may be configured as needed depending on the specifics of a process, the needs of a particular customer, etc. Sharing the same platform allow each module to feed and receive useful information from others.

For example, if the YiEES system, for example the offline analysis part (to be discussed later herein), found a strong correlation between a specific tool-related parameter (such as etch time) with a material-related parameter of interest (e.g., leakage current of transistors), this knowledge is saved in the knowledge base 368 as part of the tool profile and/or used to create or update existing, models related to this tool/or process in process control, prediction, and/or process optimization. A plug-and-play module 340 that is coupled with data/connectivity layer 330 may monitor etch time values (e.g., with high/low limit) and use the result of that monitoring to control the tool and/or optimize the tool and/or process in order to ensure the process is controlled/optimized to satisfy a particular leakage current specification. The new knowledge can also be used by existing module for new model creation or existing, model updates. This is an example of a plug-and-play tool that can be configured and updated quickly by the tool user and plugged into data/connectivity platform 330 to receive integrated tool-related and material-related data (e.g., both cause and effect data) and to provide additional control/optimization capability to satisfy a customer-specific material-related parameter of interest.

As another example, if the YiEES system, for example the off-line analysis part (to be discussed later herein), found a strong correlation between a group of specific tool-related parameters (such as etch time and chamber pressure and RF power to the electrodes) with a material-related parameter of interest (e.g., critical dimension of a via), this knowledge is saved in the knowledge base as part of the tool profile and/or used to create or update existing models related to this tool/or process in process control, prediction, and/or process optimization. A plug-and-play module 342 that is coupled with data/connectivity layer 330 may monitor values associated with this group of specific tool-related parameters (which may be conceptualized as a virtual parameter that is a composite of individual tool-related parameters) and use the result of that monitoring to control the tool and/or optimize the tool and/or process in order to ensure the process is controlled/optimized to satisfy a particular via CD (critical dimension) specification. The new knowledge can also be used by existing module for new model creation or existing model optimization. This is an example of another plug-and-play tool that can be configured and updated quickly by the tool user and plugged into data/connectivity platform 330 to receive integrated tool-related and material-related data (e.g., both cause and effect data) and to provide additional control/optimization capability to satisfy a customer-specific material-related parameter of interest or a group of material-related parameters of interest.

As another example, if the YiEES system, for example the off-line analysis part (to be discussed later herein), found a strong correlation between specific tool-related (e.g., temperature) parameter and/or material-related (e.g., leakage current) parameter with yield, this knowledge is saved in the knowledge base as part of the tool profile and/or used to create or update existing models related to this tool/or process in process control, prediction, and/or process optimization. Plug-and-play module 344 or plug-and-play module 346 that is coupled with data/connectivity layer 330 in order to monitor these specific tool-related parameter (e.g., temperature) and material-related parameter (e.g., leakage current) may predict the yield with high data granularity. The new knowledge can also be used by existing module for new model creation or existing model optimization. Each of modules 344 or 346 is an example of a plug-and-play tool that can be configured and updated quickly by the tool user and plugged into data/connectivity platform 330 to receive integrated tool-related and material-related data (e.g., both cause and effect data) and to provide analysis and/or prediction capability to satisfy a customer-specific yield requirement.

Online integrated tool-related and material-related database 348 represents a data store that stores at least sufficient data to facilitate the online control/analysis needs of modules 340-346. Since database 348 conceptually represents the data store serving the online control/analysis needs, archive tool-related and material-related data from past processes may be optionally stored in database 348 (but not required in database 348 in one or more embodiments).

Offline analysis layer 308 represents the layer that facilitates off-line data extraction, analysis, viewing and/or configuration by the user. In contrast to online control/analysis layer 306, offline analysis layer 308 relies more heavily on archival data as well as analysis result data from online control/analysis layer 306 (instead of or in addition to the data currently collected from tools 310-316 and wafers 320-324) and/or knowledge base and facilitates interactive user analysis/viewing/configuration.

A data/connectivity platform 360 serves to interface with online control/analysis layer 306 to obtain the data currently collected from tools 310-316 and wafers 320-324, from the analysis result data from the plug-and-play modules of online control/analysis layer 306, from the data stored in database 348, from a knowledge base front the archival, database 362 (which stores tool-related and material-related data), and/or from the legacy databases 364 and 366 (which may represent, for example, third-party or customer databases that may have tool-related or material-related or analysis results that may be of interest to the off-line analysis).

Data/connectivity platform 360 also presents a standard interface to communicate with the plug-and-play offline modules. For example, data/connectivity platform 360 may implement APIs (application programming, interfaces) with pre-defined connectivity and communication options for the offline plug-and-play extraction module or offline plug-and-play configuration module or offline plug-and-play analysis module or offline plug-and-play viewing module The off-line plug-and-play modules may be implemented via dedicated logic or as software executed in a programmable logic/processor, for example. These offline extraction, analysis, configuration and/or viewing modules may be quickly configured as needed by the customer and plugged into data/connectivity platform 360 to receive current and/or archival integrated tool-related and material-related data (e.g., both cause and effect data) as well as current and/or archival online analysis results and/or data from third party databases in order to service a specific extraction, analysis, configuration and/or viewing need.

Interaction facility 370 conceptually implements the aforementioned offline plug-and-play modules and may be accessed by any number of user-interface devices, including for example smart phones, tablets, dedicated control devices, laptop computers, desktop computers, etc. in terms of viewing, different industries may have different preferences for different viewing methodologies (e.g., pie chart versus timeline versus spreadsheets). A web server 372 and a client 374 are shown to conceptually illustrate that offline extraction, analysis, configuration and/or viewing activities may be performed via the internet, if desired.

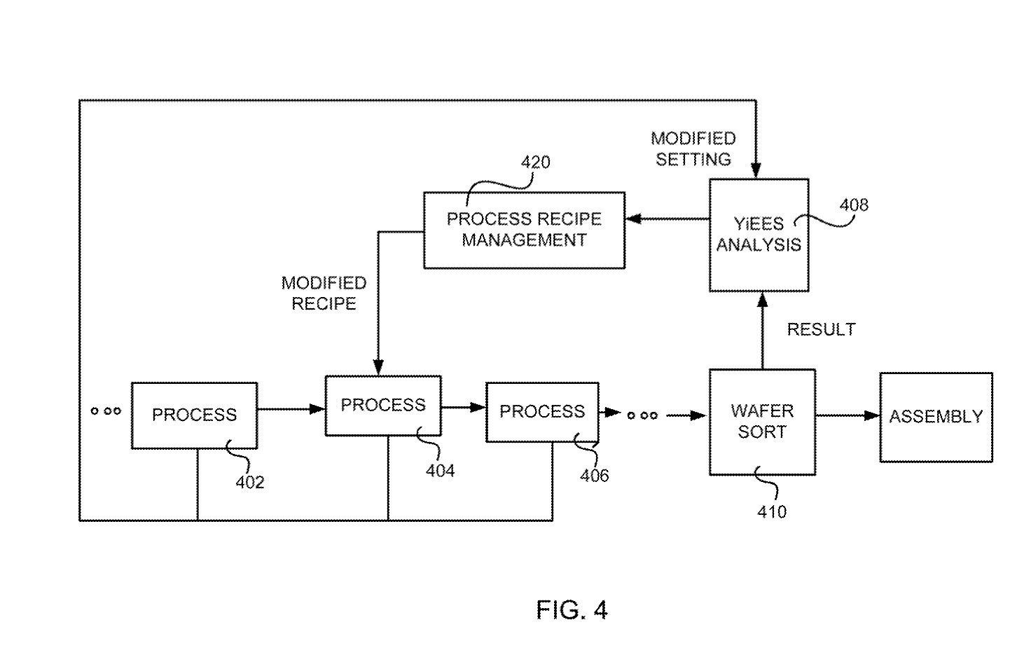

FIG. 4 shows the implementation of an example online control/optimization module that is analogous to the plug-and-play modules discussed in connection with online control/analysis layer 306 of FIG. 3. In FIG. 4, the tool-related data from processes 402, 404, and 406 (which may represent respectively metal etch, polysilicon etch, and CMP, for example) may be collected and inputted into a control/optimization module 408. Once processing is done, wafer sort process 410 may perform electrical parameter measurements, device yield measurements, and/or other measurements and input the material-related data into control/optimization module 408.

Control/optimization module 408, which represents a plug-and-play module, may automatically analyze the tool-related data and the material-related data and determine that there is a correlation between chamber pressure during the polysilicon etch step (a tool-related data parameter) and the leakage current of a gate (a material-related data parameter). This analysis result may be employed to modify a recipe setting, which is sent to process recipe management block 420 to create a modified recipe to perform tool control or to optimize tool control for tool 404. Note that the presence of highly granular tool-related data and material-related data permit root cause analysis that narrows down to one or more specific parameters in a specific tool, which facilitates highly accurate recipe modification. Accordingly, the availability of both tool-related data and material-related data and the ease of configuring/implementing a plug-and-play module to perform the analysis on the integrated tool-related data and material-related data greatly simplify the automated analysis and control task. In addition, based on the above analysis, a prediction model can be built or optimized and its results can be passed to other plug and play modules (for example 406) as inputs. This is also an example of feed-forward and feed-backward capability of the plug and play module in the system.

Automated analysis of effect (e.g., yield result based on integrated tool-related and material-related data) and/or prediction (e.g., predicted yield result based on integrated tool-related and material-related data) may be improved using a knowledge base. In one or more embodiments, human experts may input root-cause analysis or prediction knowledge into a knowledge base to facilitate analysis and/or prediction. The human expert may, for example, indicate a relationship between saturation current measurements for a transistor gate and polysilicon critical dimension (C/D).

Previously obtained root-cause analysis (which pinpoints tool-related parameters correlating to yield-related problems) and previously obtained prediction models from the YiEES system (such as from one or more of plug-and-play modules 340-346 of online control/analysis layer 306 of FIG. 3 or one or more of plug-and-play modules of online analysis layer 308) may also be input into the knowledge base. For example, prior analysis may correlate a particular etch pattern on the wafer with a particular pressure setting on a particular tool. This correlation may also be stored into the knowledge base.

The root-cause analysis and/or prediction knowledge from the human expert and/or from prior analysis/prediction module outputs may then be applied against the integrated tool-related data and material-related data to perform root cause analysis or to build new prediction models. The combination of a knowledge base, tool-related data, and material-related data in a single platform renders the automated analysis more accurate and less time-consuming.

In one or more embodiments, multiple potential root causes or prediction models may be automatically provided by the knowledge base, along with a ranking of probability, in order to give the tool operator multiple options to investigate. Furthermore, the root-cause analysis and/or prediction models obtained using the assistance of the knowledge base may be stored back into the knowledge base to improve future root-cause analysis and/or prediction. To ensure the accuracy of the generated root-cause analysis or prediction models, cross validation using independent data may be performed periodically if desired.

Expert or domain knowledge may also be employed to automatically filter the analysis result candidates or influence the ranking (via changing the weight assigned to the individual results, for example) of the analysis result candidates. For example, the set of candidate analysis results (obtained with statistical method alone or with or without know ledge base assistance) may be automatically filtered by expert or domain knowledge to de-emphasize certain analysis result, or emphasize certain analysis result, or eliminate certain analysis result, in order to influence the ranking of the analysis result candidates.

As an example, the expert may input, as a rule into the analysis engine, that yield loss around the edge is likely associated with etch problems and more specifically with high bias power during the main etch step. Accordingly, the set of analysis result candidates that may have been obtained using a purely statistical approach or a combination of a statistical approach and other knowledge base rules may be influenced such that those candidates associated with etch problems and more specifically those analysis results associated with high bias power during main etch step would be emphasized (and other candidates de-emphasized). Note that this type of root cause analysis granularity is possible only with the provision of integrated tool-related data and material-related data in a single platform, in accordance with one or more embodiments of the invention.

Analysis may, alternatively or additionally, be made more efficient/accurate by first performing automated clustering/classification of wafers, and then applying different automated analyses to different groups of wafers. With the availability of material-related data, it is possible to duster or classify the processed wafers into smaller subsets for more efficient/accurate analysis.

For example, the processed wafers may be grouped according the processed patterns (e.g., over-etching along the top half, over-etching along the bottom half, etc.) or any tool-related parameter (e.g., chamber pressure) or any material-related parameter (e.g., a particular critical dimension range of values) or any combination thereof. Note that this type of classification/clustering is possible because both highly granular tool-related and material-related data are available and aligned on a single platform. Generically speaking, clustering/classification aims to group subsets of the materials into “single cause” groups or “single dominant cause” groups to improve accuracy in, for example, root-cause analysis. For example, when a subset of the materials (e.g., wafers) are grouped into a group that reflects a similar process result or a set of similar process results, it is likely to be easier to pinpoint the root cause for the similar process result(s) for that subset than if the wafers are arbitrarily grouped into arbitrary subsets/groups without regard for process result similarities or not grouped at all.

Classification refers to applying predefined criteria or predefined libraries to the current data set to sort the wafer set into predefined “buckets”. Clustering refers to applying statistical analysis to look for common attributes and creating; sub-sets of wafers based on these common attributes/parameters.

In accordance with one or more embodiments, different types of analysis may then be applied to each sub-set of wafers after classification/clustering. By way of example, if a sub-set of wafers has been automatically grouped based on a specific range of critical dimension and it is known that critical dimension is not influenced by process gas flow volume, for example, considerable time/effort can be saved by not having to analyze that subset of wafers for correlation with process gas flow.

However, that subset of wafers may be analyzed in a more focused and/or detailed manner using a particular analysis methodology tailored toward detecting problems with critical dimensions. Examples of different analysis methodologies include equipment analysis, chamber analysis, recipe analysis, material analysis, etc.

In accordance with one or more embodiments, different statistical methods may be applied to different subsets of wafers after clustering/classification (depending on, for example, how/why these wafers are classified/clustered and/or which analysis methodology is employed). For example, a specific statistical method may be employed to automatically analyze wafers grouped for equipment analysis while another specific statistical method may be employed, to analyzed wafers grouped for recipe analysis. This is unlike the prior art wherein a single statistical method tends to be employed for all root-cause analyses for the whole batch of wafers. Since both tool-related and material-related data are available, automated analysis may pinpoint the root-cause to a specific tool parameter or a specific combination of tool parameters. This type of data granularity is not possible with prior art systems that only have tool-related data or material-related data.

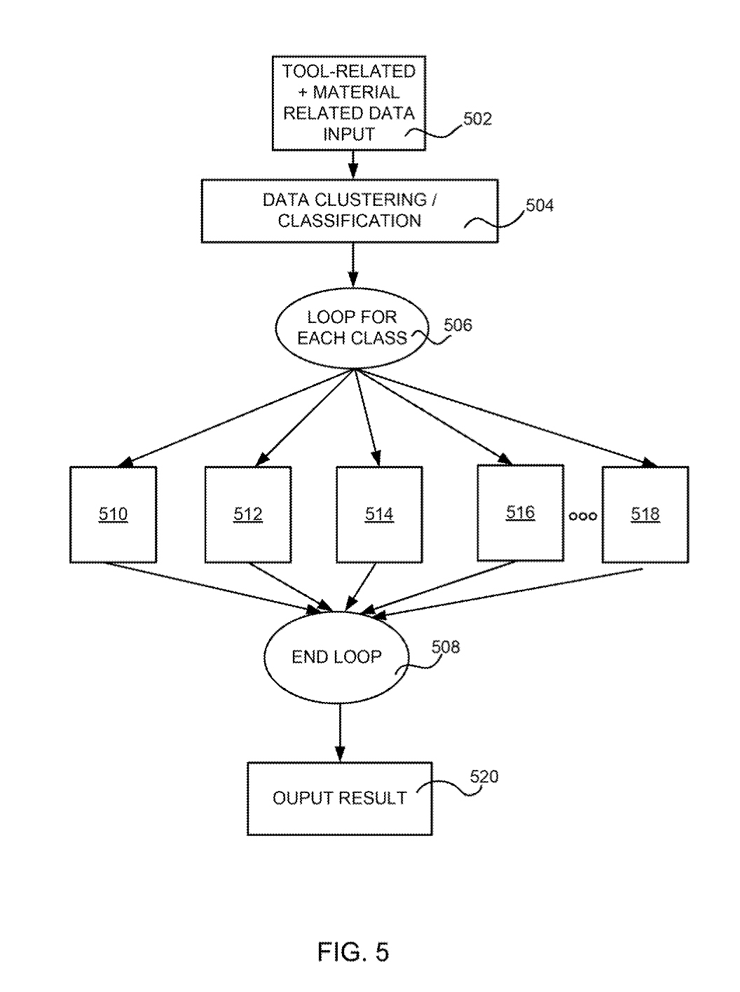

FIG. 5 illustrates, in accordance with an embodiment of the invention, the improved analysis technique with pre-filtering via classification/clustering and/or using different analysis methodologies and/or different statistical techniques. In block 502, the integrated tool-related data and material-related data are inputted. In block 504, data clustering and/or data classification may be performed on the wafers to create subsets of wafers as discussed earlier. These subsets of wafers are analyzed using suitable analysis methodologies (blocks 510, 512, 514, 516, 518) until all subsets are analyzed (iterative blocks 506 and 508. As discussed, a specific statistical method may be employed to analyze wafers grouped for equipment analysis (510) while another specific statistical method may be employed to analyzed wafers grouped for recipe analysis (516), for example. The analysis results are then outputted in block 520.

As can be appreciated from the foregoing, the integration and data alignment of both cause and effect data (e.g., tool-related data and material-related data) In the same platform simplify the task of automatically correlating data from traditional EES system and YMS system, as well as facilitate time-efficient automated analysis. The use of automated data alignment and automated analysis also substantially eliminates human-related errors in the data correlation and automated data analysis tasks. Since high granularity tool-related data and process-related data are available on a single platform, both automated root cause analysis and automated prediction may be more specific and timely, and it becomes possible to quickly pinpoint a yield-related problem to a specific tool-related parameter (such as chamber pressure in tool #4) or a group of tool-related parameters (such as chamber pressure and bias power in tool #2). Furthermore, the use of knowledge base and/or cross-validation and/or wafer clustering/classification also improves the automated analysis results.

In accordance with embodiments of the invention, there are provided techniques for automatically and/or systematically include more data sources and/or more detailed data in the analysis, prediction, and model building. In one or more embodiments, process data (e.g., temperature, gas flow, valve positions, etc.) are also included such that it is possible to not only narrow the root cause analysis down to a given tool, for example, but also pinpoint the process parameter excursions (such as chamber pressure excursions) that cause the result under investigation (such as an etch profile anomaly at the substrate edge).

In one or more embodiments, domain knowledge and/or expert systems are automatically and/or systematically incorporated into the root cause analysis, the prediction and/or the model building to improve results and/or to reduce the reliance on inconsistent and expensive human experts.

Furthermore, the input data set (such as the quality/material data set) is segmented and categorized so as to de-emphasize/eliminate unimportant parameters and to improve the signal-to-noise ratios of the important parameters. The parameters to be analyzed may be processed using one or more appropriate statistical techniques depending on the type of data involved.

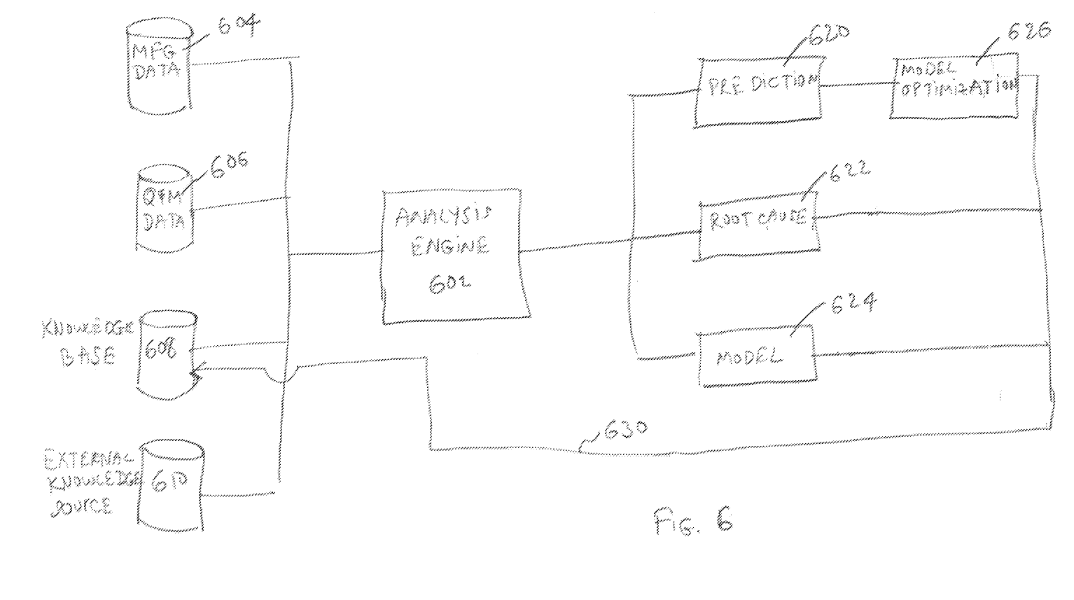

FIG. 5 illustrates, in accordance with an embodiment of the present invention, a flow diagram for systemizing and improving the results of root cause analysis, prediction, and model building. With respect to FIG. 6, an analysis engine 602 receives as inputs a variety of input information sources such as manufacturing, data 604, quality/material data 606, knowledge base 608, and external knowledge source 610.

Manufacturing data 604 represents data collected during the manufacturing of the material and may include for example tracking data (which equipment is used, who operates the equipment, etc.), process data (temperature, pressure, voltage, current, etc.) and facility data (temperature of the fab, flow of gas in the fab) and may include historical profile data (e.g., historical information about the tool, and the process).

Quality/material data 606 may be thought of as including the aforementioned YMS data and may include material-related data such as thickness of film deposited, CD, electrical measurements during and after the process (e.g., wafer electrical test—WET) to assess the quality of the devices formed, measurements of quality of the dies based on functional measurements (measurements of dimensions, electrical parameters, etc.). Quality/material data 606 may also include bit map data on memory devices to determine the quality of the memory bits, for example.

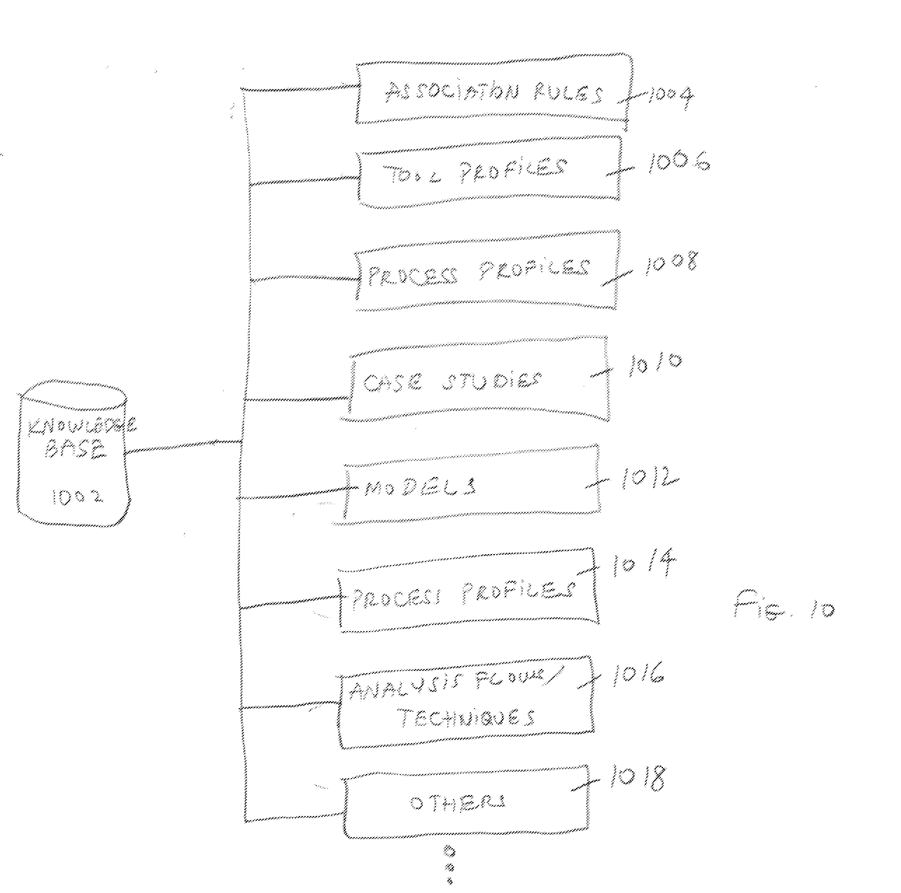

Knowledge base 608 represents the data store of historical cases and domain knowledge. Knowledge base 608 is discussed further in connection with FIG. 10 herein.

External knowledge source 610 represents the external information inputted by experts or users to further tune the analysis/prediction/model building process. As an example, a human expert may be aware that a certain type of etch problem tends to be caused by excursions in one or more specific parameters. By excluding other parameters from the analysis and/or putting different weights on different parameters, external knowledge source 610 may be employed to improve the signal-to-noise ratio of the root cause analysis/prediction/model building processes (i.e., tune the process to make the process more sensitive as a detection mechanism).

Analysis engine 602 outputs prediction 620, root cause 622, and models 624. Prediction 622 represents the prediction result about a particular tool or a particular wafer process given the current data collected from the tool (e.g., pressure, temperature, valve location, etc.), the historical tool data, and the recipe. Such prediction may be used to predict when maintenance may be required or may be employed as a “virtual metrology” tool to predict the etch result (e.g., the critical dimension or CD) for a particular location of a particular water.

Prediction results may be employed to verify existing models from knowledge base 608, thus optionally optimizing the existing models (block 626) with updated modeling results.

Root cause 622 represents the output from the root cause analysis process. In root cause analysis, the focus is on identifying the root cause of some material process result, often a process result anomaly, from the input data set. As an example, if the wafer process result shows low yield at the wafer edge, root cause analysis may be employed to ascertain the process parameter excursions that may be responsible for the process result anomaly. In accordance with embodiments of the present invention, such level of granularity is possible since the root cause analysis employs not only tracking data and equipment data but also process data, historical data, and/or knowledge base and/or expert system to focus in a particular subset of a piece of equipment or a particular parameter.

Model 624 represents the output from the model building process, which is employed to create models to predict conditions of the tool or to predict the process results. For example, in a practice sometimes referred to as virtual metrology, a model may be employed to predict the critical dimensions of devices formed from the input data such as the tool's current conditions, the tool's historical data, process parameters such as temperature, pressure, power, etc. As another example, a model may be employed to predict when the tool may require maintenance. Models 624 may be created and stored in knowledge base 608 for future use, for example.

FIG. 6 also shows a feedback 630, representing the case results from the prediction process (prediction 620), root cause analysis (root cause 622), model building process (models 624) into knowledge base 608 for future use. As mentioned, knowledge base 608 will be discussed later herein in connection with FIG. 10.

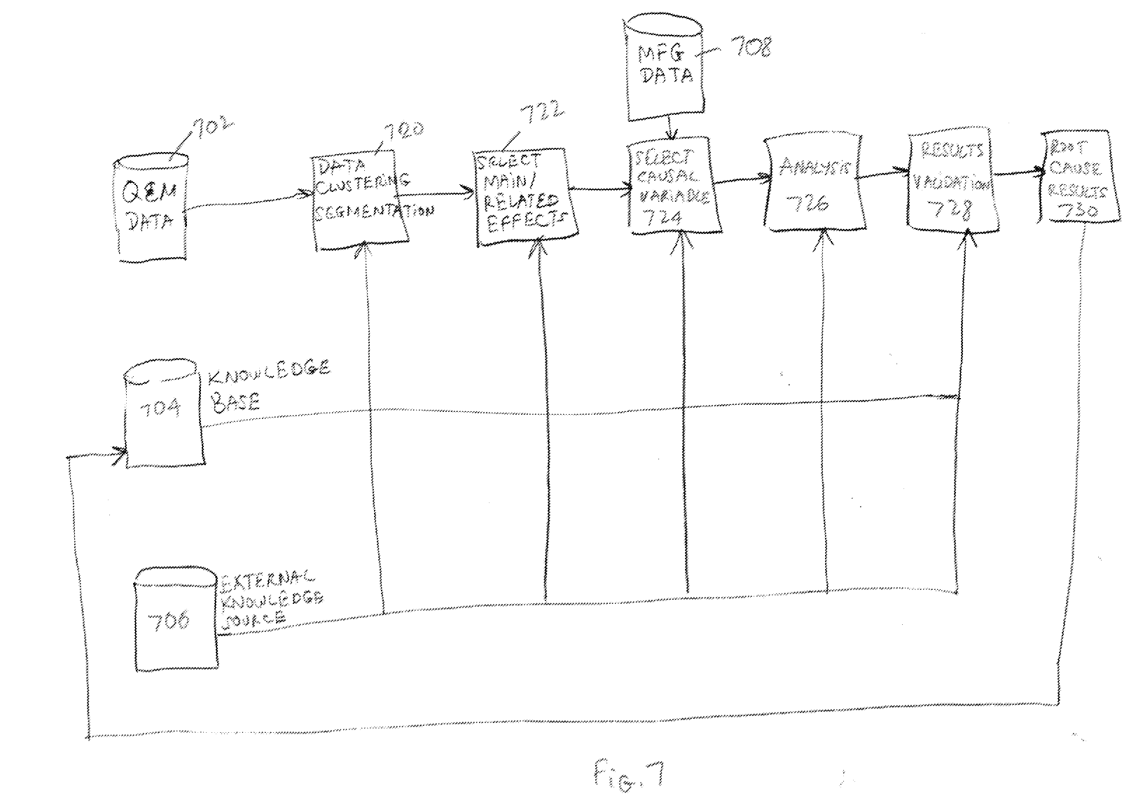

FIG. 7 shows, in accordance with an embodiment of the present invention, detailed steps implementing the root cause analysis to produce the root cause result (622 of FIG. 6). As shown in FIG. 7, the quality and material data 702, knowledge base 704, external knowledge source 706, and manufacturing data 708 are employed as inputs. Quality and material data 702 may be thought of as representing effect data (e.g., what is produced by the manufacturing process) while manufacturing data 708 may be thought of as representing causation data (e.g., the manufacturing parameters/conditions). On the other hand, knowledge base 704 and external knowledge source 706 may be thought of as supplemental data to improve the root cause analysis result.

Referring now to FIG. 7, step 720 represents an optional clustering/segmentation step where the input quality and material data 702 is partitioned into separate data sets wherein each separate data set contains only one independent dominant effect. The goal of step 720 is to improve the signal-to-noise ratio by isolating effects into individual independent data sets prior to analysis. One skilled in the art would readily appreciate that by such effect isolation, changes or trends in the isolated effect data may be more readily ascertained. The clustering/segmentation may be performed algorithmically in an embodiment. Alternatively or additionally, domain knowledge and/or external knowledge (704 and/or 706) may be employed to assist in the clustering/segmentation step (e.g., human users or experts may provide inputs regarding dominant effect).

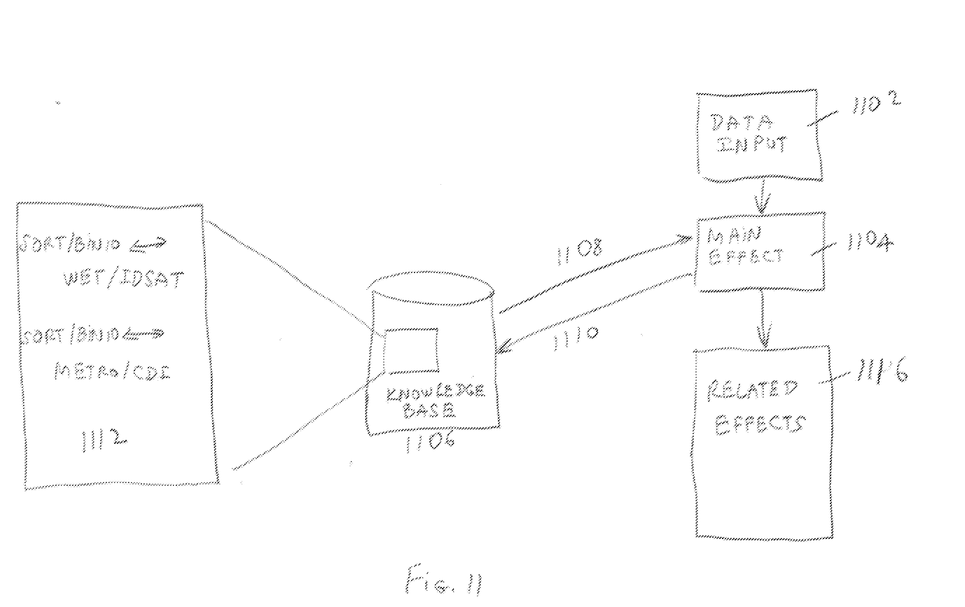

Step 722 represents the selection of main and related effects for root cause analysis from the independent data sets produced from step 720. A main effect (e.g., poor wafer edge yield) may be selected for root cause analysis. Related effects (e.g., saturation current) may also be selected. As will be discussed in connection with FIG. 11, related effects may be ascertained for each independent effect, with effect associations forming association rules stored in knowledge base 704. These pre-stored association rules may be employed to select the related effects. Alternatively or additionally, related effects may also be ascertained algorithmically from the independent data sets produced from step 720 if no association rules exist for the chosen main effect and/or external expert knowledge (from 706) may be employed to select main/related effects.

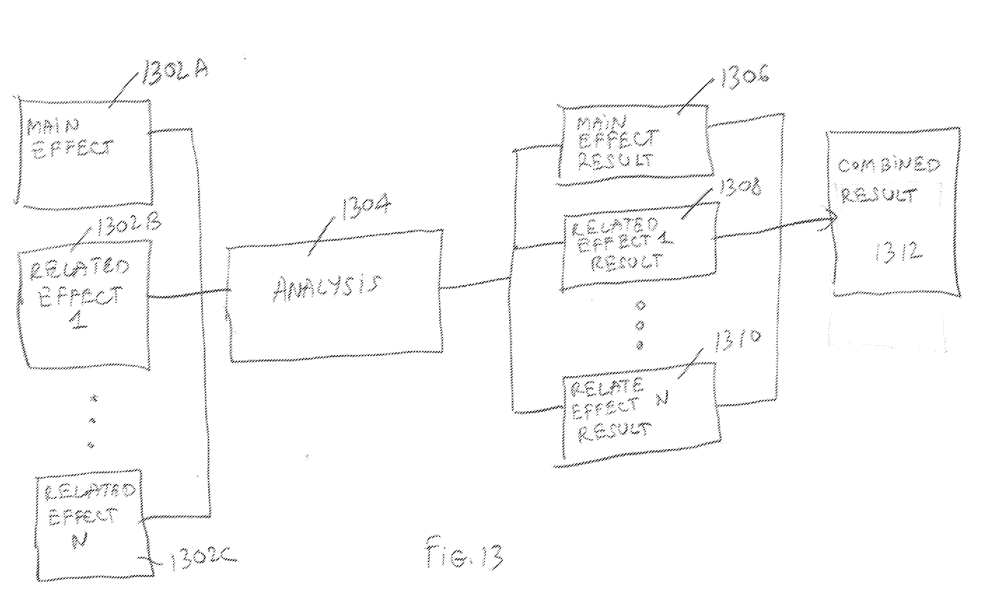

Step 724 pertains to the selection of the causal variables from manufacturing data. Again, knowledge base 704 and/or external knowledge source 706 may be employed to select cancel causal variables for analysis purposes. For example, case studies in the past may suggest that chamber pressure and wafer bias voltage (causal variables) are irrelevant to edge defects (effect variable) while RF power (another causal variable) tends to have a strong relationship with edge defects. Accordingly, RF power may be selected or more heavily weighted for the analysis while chamber pressure and wafer bias voltage may be eliminated or lessened in weight for the analysis. FIG. 13 discusses an implementation of step 724 in greater details.

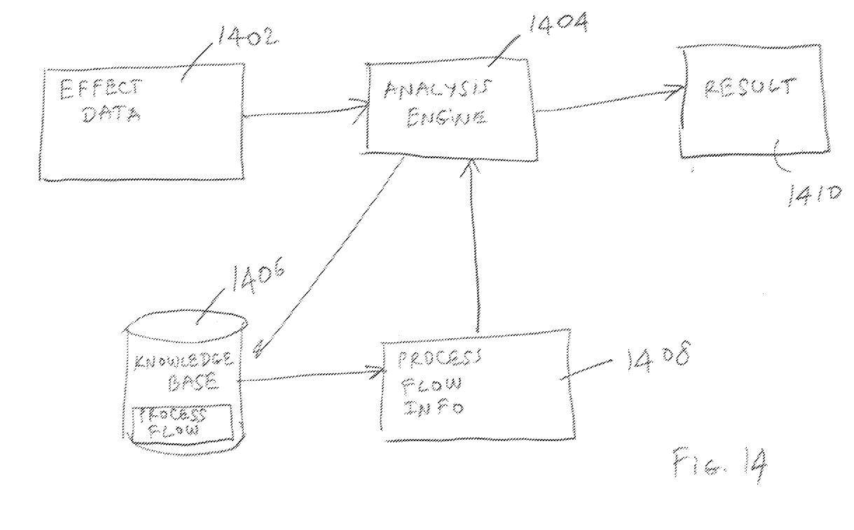

Step 726 pertains to the analysis of the effects, represented by independent data sets segmented in step 720 and in combination with related data sets ascertained in step 722. The analysis uses the weighted and/or filtered causation variables of step 724. In one or more embodiments, the analysis employs hierarchical data organization and also leverages on domain knowledge and external expert data sources (704 and 706). In one or more embodiment, process flow data is also employed to improve result granularity. These aspects are discussed further in connection with FIGS. 14, 15 and 16 herein.

The results are then cross-validated in step 728. Cross-validation may independently analyze each effect in the main/related effect data set and ascertain whether both point to the same causal variable behavior (such as a spike in chamber pressure). Cross-validation may also involve comparing current analysis result with historical result to determine if the current analysis result follow the general trend or is an anomaly analysis result (which would warrant further attention or would invalidate the analysis). The result of validation (which may be positive or negative) may be stored in knowledge base 704 for future use.

As mentioned, embodiments of the invention may involve multiple analysis techniques involving a variety of data sources. Accordingly, the root cause analysis may produce multiple results in an embodiment. The results may be ranked and displayed in step 730. Further, the results may be stored in knowledge base 704 in the form of case studies for future use.

As can be seen in FIG. 7, knowledge base 704 and/or external knowledge source 706 may be employed in one or more of steps 720, 722, 724, 726, and 728 to improve the analysis result.

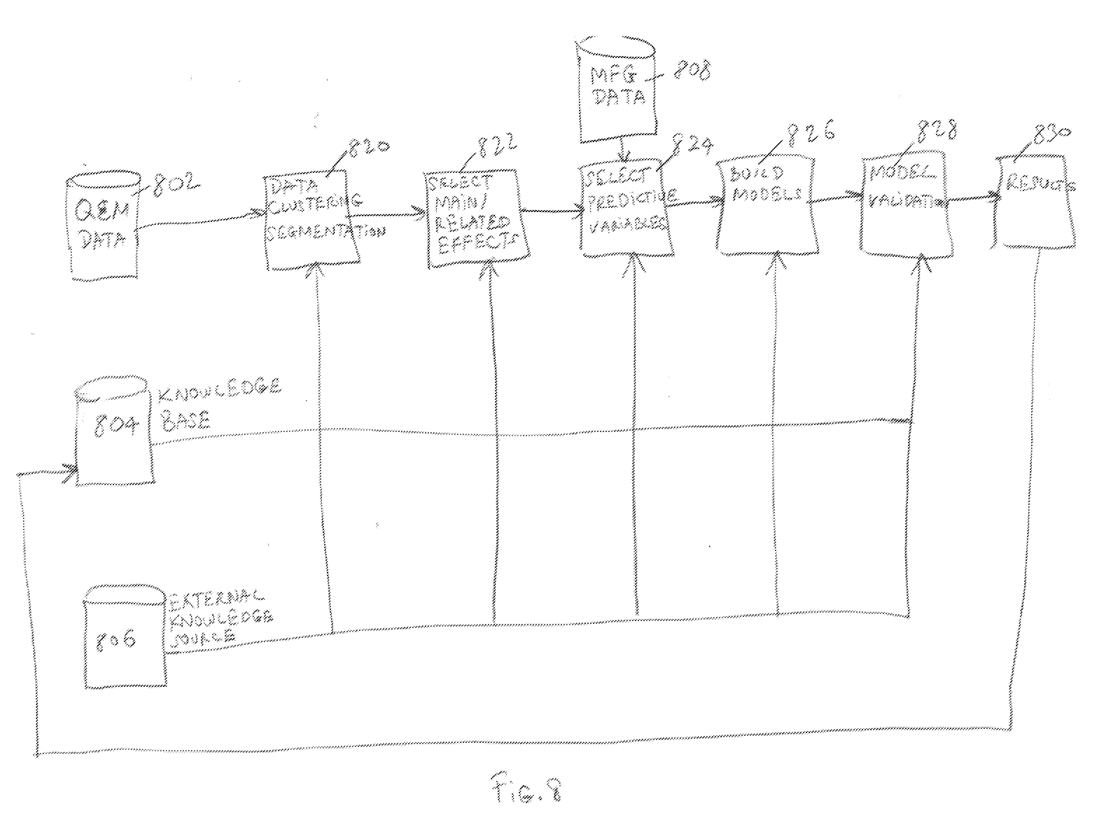

FIG. 8 illustrates, in accordance with an embodiment of the invention, the model building process (which produces the models in block 624 of FIG. 6). As shown in FIG. 8, the quality and material data 802, knowledge base 804, external knowledge source 806, and manufacturing data 806 are employed as inputs. Quality and material data 802 may be thought of as representing effect data (e.g., what is produced by the manufacturing process) while manufacturing data 808 may be thought of as representing causation data (e.g., the manufacturing parameters/conditions). On the other hand, knowledge base 804 and external knowledge source 806 may be thought of as supplemental data to improve the modeling results.

The goal of step 820 is to improve the signal-to-noise ratio by isolating effects into individual independent data sets prior to analysis. One skilled in the art would readily appreciate that by such effect isolation, changes or trends in the isolated effect data may be more readily ascertained. The clustering/segmentation may be performed algorithmically in an embodiment. Alternatively or additionally, domain knowledge and/or external knowledge (804 and/or 806) may be employed to assist in the clustering/segmentation step (e.g., human users or experts may provide inputs regarding dominant effect).

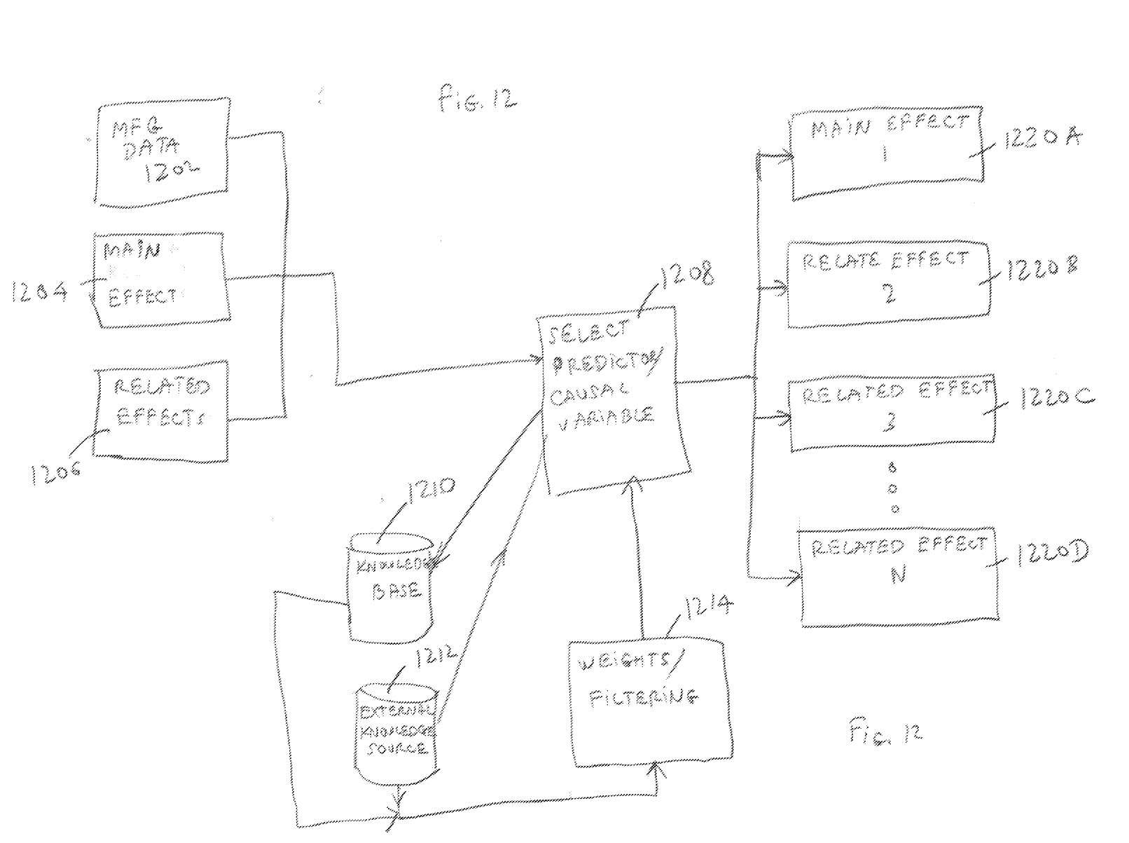

Step 822 represents the selection of main and related effects for model building from the independent data sets produced from step 820. Step 824 pertains to the selection of the predictor variables from manufacturing data. Again, knowledge base 804 and/or external knowledge source 806 may be employed to select/cancel/weight/filter predictor variables for model building purposes. FIG. 12 discusses an implementation of step 824 in greater details.

Step 826 pertains to the model building step based on independent data sets segmented in step 820 and in combination with related data sets ascertained in step 822. The model building uses the weighted and/or filtered predictor variables of step 824. In one or more embodiments, the model building employs hierarchical data organization and also leverages on domain knowledge and external expert data sources (804 and 806). In one or more embodiment, process flow data is also employed to improve model granularity.

The models are then validated in step 828 and the result of validation may be stored in knowledge base 804 for future use. The result of model building is outputted in step 830 may be stored in knowledge base 804 for future use.

As can be seen in FIG. 8, knowledge base 804 and/or external knowledge source 806 may be employed in one or more of steps 820, 822, 824, 826, and 828 to improve the model(s) built.

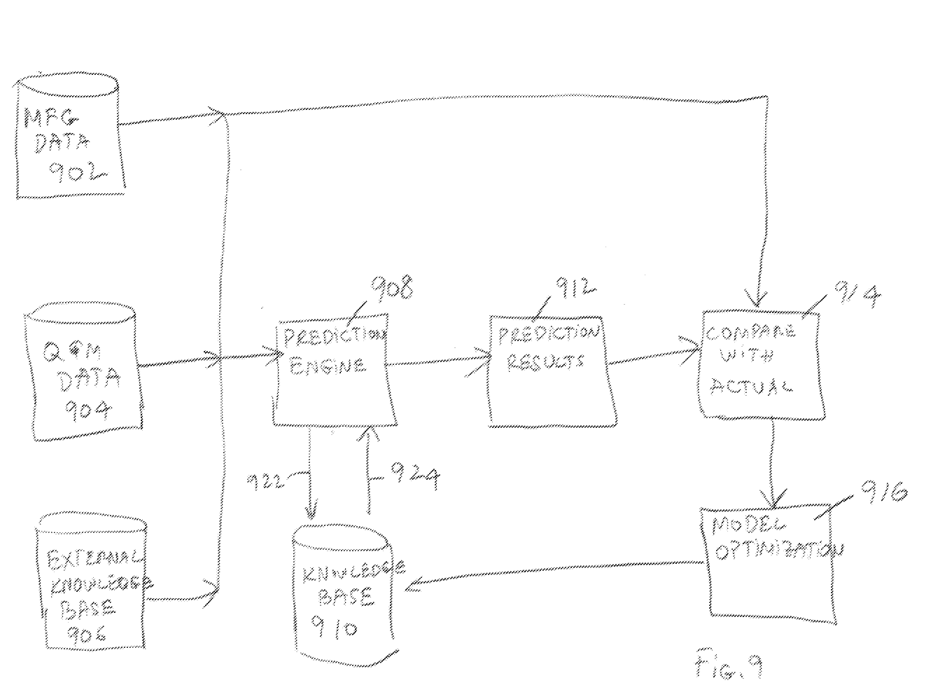

FIG. 9 shows, in accordance with an embodiment of the present invention, an implementation of the prediction process that produces predictions 620 of FIG. 6. As can be seen in FIG. 9, manufacturing data 902 and quality/material data 904 (either in its raw form or segmented/partitioned as discussed earlier) and external knowledge source 906 represent the inputs into a prediction engine 908. Prediction engine 908 selects a model (see FIG. 8) from knowledge base 910 for the prediction (via arrows 922 and 924). The selection may be based on an index search of knowledge base 910 or may be based on groupings of input variables (e.g., types of causal/effect variables, combinations of causal/effect variables, range of causal/effect variables) or based on tool profiles, process profiles, etc. Expert knowledge from external knowledge source 906 may also be employed in the model selection for use by prediction engine 908.

If multiple models are employed, the prediction process may result in multiple prediction results (912). The prediction results may be validated by comparing with actual results in step 914. As an example, multiple models may be employed to predict when the system needs to be taken down for maintenance. The prediction result may be multiple predictions in step 912. When the actual maintenance time arrives, the actual maintenance time may be compared to the prediction result in order to optimize the model (step 916). The revised model(s) or new models from the optimization step may be stored in knowledge base 910 for future use.

FIG. 10 shows, in accordance with an embodiment of the invention, some example constituent data in the knowledge base. For example, knowledge base 1002 may include association rules 1004 (which associate related effects to one or more independent effect(s). Knowledge base 1002 may also include historical/current tool profiles 1006 (e.g., what kind of tool, maintenance history, usage history, etc.), historical/current process profiles 1008 (e.g., what kind of process, process result or problem history, etc.), case studies 1010 (e.g., linkages or relationships between one or more causal variables to one or more result variables), models 1012, current/historical data pertaining to process flows (1014), current/historical data pertaining to process flows and techniques (1016) and other (1018) historical/current profiles or case studies or data.

FIG. 11 illustrates, in accordance with an embodiment of the invention, associating main and related effects, which are employed for root cause analysis (see step 722 of FIG. 7) or prediction (see step 822 of FIG. 8). Data input 1102 represents the quality/material data in either its raw form or independently segmented/partitioned form. In step 1104, a main effect for analysis or prediction may be selected by the user or ascertained algorithmically. As an automatic example, wafer map results may be automatically filtered for bad bins, and the defects can be algorithmically clustered according, to defect types to isolate one main effect automatically (such as edge defects). The process may consult knowledge base 1106 and more specifically association rules 1112 in knowledge base 1106 (see arrows 1108 and 1110) in order to determine the related effects that may be associated/related to the main effect determined in step 1104. The association rules may be established by domain knowledge or by case studies analysis from past cases that establish correlations between effects. There may be multiple related effects (e.g., metrology critical dimension 1 and WET/IDSAT) for any single effect (e.g., Sort/Bin10) as shown in association rules 1112. The result of the association process of FIG. 11 is a set of related effects (1116) for the main effect of step 1104.

FIG. 12 shows the steps for selecting predictor variable or causal variable, implementing in an embodiment step 724 of FIG. 7 or 824 of FIG. 7. As can be seen in FIG. 12, the input manufacturing data (1202), main and related effects (1204 and 1206) are input into an engine 1208 for selecting, the predictor/causal variable. Knowledge base 1210 and/or expert knowledge from external knowledge source 1212 may provide weights or filtering information (1214) in order to filter or weigh the input variables, resulting a smaller subset of the input variables to be used as predictor or causal variables (1220A, 1220B, 1220C, and 1220D).

FIG. 13 shows, in accordance with an embodiment of the invention, the implementation of the analysis step 726 of FIG. 7. As can be seen in FIG. 13, the main and related effect data sets (1302A, 1302B and 1302C) along with the selected causal variables (and optionally knowledge base and/or external knowledge source) are input into an analysis process (1304) that produces analysis for the main effect data set as well as for the related effect data sets (1306, 1308, and 1310). The results may optionally be combined to produce a combined analysis conclusion (1312). The use of independent data sets improve the signal-to-noise of the analysis and provide a mechanism for cross-validation, as discussed earlier.

FIG. 14 shows the use of process flow data to improve the analysis, prediction or modeling. Root cause analysis is employed as an example in FIG. 14. Main and related effect data sets (1402) are input into analysis engine 1404, which consults knowledge base 1406 in order to obtain process flow information 1408. Process flow 1408 represents the process step sequence (e.g., etch step 1, deposition step 2, etc.) may be used to filter out process steps that are irrelevant to the analysis or modeling or prediction in order to improve (1410) the analysis/prediction/modeling,

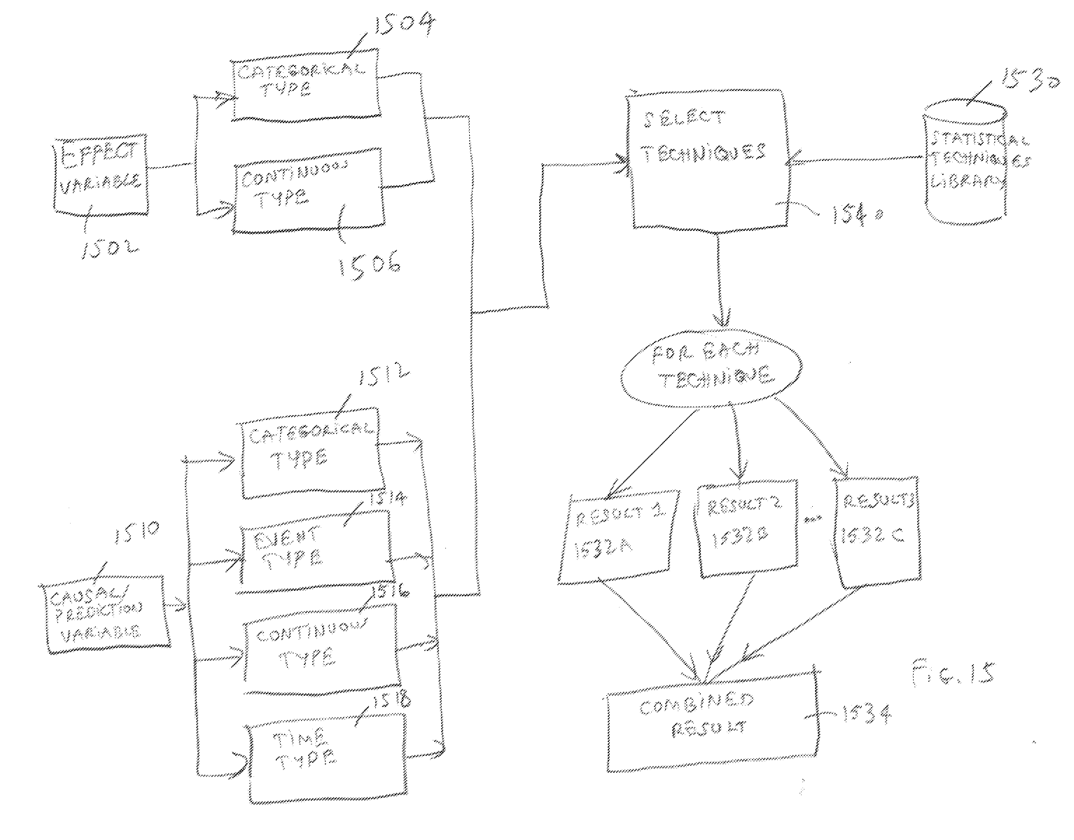

FIG. 15 shows, the hierarchical organizing of effect data and causal/prediction data in order to more appropriately apply the appropriate statistical/analysis techniques to obtain improved root cause analysis, prediction, and/or models. In FIG. 15, effect variables (1502) may be categorized into at least categorical types 1504 (e.g., discrete categories that may be predefined for the type) or continuous 1506 (e.g., real numbers). Causal/predictor variables 1510 may be categorized into at least categorical types 1512 (based on predefined categories), event type 1514 (e.g., a recipe change, the opening of the chamber, etc.), continuous type 1516, and time type 1518.

After categorization, statistical techniques appropriate for different combinations of the effect and causal/predictor types ma be selected from statistical library 1530 in order to perform the root cause analysis or prediction or model building. Examples of these statistical techniques include, for example correlation analysis, analysis of variance (ANOVA), linear regression, logistic regression, least angle regression (LARS), principal component analysis (PCA), partial least square (PLS), rule induction, non-parametric statistical tests, goodness of fit test, Bayesian inference, sequential analysis and time series analysis.

The techniques chosen are applied to various combinations of the input effect data and causal/prediction data (1340) in order to produce results 1332A, 1332B, and 1332C. For example, the categorical effect type and categorical causal/prediction type combination may lead to the use of a given statistical technique while the combination of a continuous effect type and event causal/prediction type may lead to the use of a different statistical technique. Multiple techniques may be chosen, which yield multiple results. These results may be filtered and/or combined to produce a combined result (step 1334) in one or more embodiments.

As can be appreciated from the foregoing, embodiments of the invention improves the root cause analysis, the prediction, and/or the model building through the systematic and automatic use of multiple data sources, including data sources previously not employed for such root cause analysis, prediction, and/or model building. For example, process data which provides information such as temperature, gas flow, RF power is systematically and automatically employed in the root cause analysis, prediction, and/or model building. Accordingly, for example, the root cause analysis result may be narrowed down to not only which tool may cause the problem but also which parameter in which step in which tool may be causing the problem.

Further, domain knowledge is systematically and automatically employed to improve the root cause analysis, prediction, and/or model building. Examples include the systematic and automatic use, in one or more embodiments, of domain knowledge in aforementioned effect data segmentation/partitioning, the selection of main and related effect data, the selection of predictor/causal data, the root cause analysis or prediction, and the root cause analysis cross-validation or model validation.

Further, effect and/or prediction/causal data are organized into hierarchy in order to enable the use of more appropriate statistical techniques or multiple statistical techniques for different combinations of effect and prediction/causal data to improve results.

Still further, the filtering of effect and/or prediction/causal data to de-emphasize or eliminate irrelevant variables renders the process more sensitive and significantly improves the signal-to-noise ratio.

While this invention has been described in terms of several preferred embodiments, there are alterations, permutations, and equivalents, which fall within the scope of this invention. For example, although the examples herein refer to wafers as examples of materials to be processed, it should be understood that one or more embodiments of the invention apply to any material processing tool and/or any material. In fact, one or more embodiments of the invention apply to the manufacture of any article of manufacture in which tool information as well as material information is collected and analyzed by the single platform. If the term “set” is employed herein, such term is intended to have its commonly understood mathematical meaning to cover zero, one, or more than one member. The invention should be understood to also encompass these alterations, permutations, and equivalents. It should also be noted that there are many alternative ways of implementing the methods and apparatuses of the present invention. Although various examples are provided herein, it is intended that these examples be illustrative and not limiting with respect to the invention.

What is claimed is:

1. A computer-implemented method for performing root cause analysis for a process result for material processed in accordance with a process, comprising:
providing quality and material (Q&M) data representing process result for said material from said process;
selecting effect data that includes at least one main effect from said Q&M data;
providing manufacturing data representing manufacturing conditions present while said material is processed in accordance with said process;
selecting causal data that includes at least one causal variable from said manufacturing data, said causal data being associated with said main effect data; and
analyzing said causal data and said effect data for analysis result, whereby root cause is derived from said analysis result.

2. The computer-implemented method of claim 1 wherein said effect data further includes related effects that are related to said at least one main effect.

3. The computer-implemented method of claim 1 wherein said Q&M data is clustered prior to said selecting said effect data.

4. The computer-implemented method of claim 1 wherein said Q&M data is segmented prior to said selecting said effect data.

5. The computer-implemented method of claim 1 further including validating said analysis result.

6. The computer-implemented method of claim 1 further comprising providing knowledge base for providing knowledge base data for use in at least one of said selecting said effect data, said selecting said causal data, and said analyzing.

7. The computer-implemented method of claim 1 further comprising providing external knowledge source for providing external knowledge data for use in at least one of said selecting said effect data, said selecting said causal data, and said analyzing.

8. A computer-implemented method for performing model building for use in predicting future process result for future processing of future material processed in accordance with a process, comprising:
providing quality and material (Q&M) data representing process result from processing material similar to said future material in accordance with said process;
selecting effect data that includes at least one main effect from said Q&M data;
providing manufacturing data representing manufacturing conditions present while said material is processed in accordance with said process;
selecting predictive data that includes at least one predictive variable from said manufacturing data, said predictive data being associated with said main effect data; and
analyzing said causal data and said effect data for analysis result, whereby at least one model is derived from said analysis result.

9. The computer-implemented method of claim 8 wherein said effect data further includes related effects that are related to said at least one main effect.

10. The computer-implemented method of claim 8 wherein said Q&M data is clustered prior to said selecting said effect data.

11. The computer-implemented method of claim 8 wherein said Q&M data is segmented prior to said selecting said effect data.

12. The computer-implemented method of claim 8 further including validating said analysis result.

13. The computer-implemented method of claim 8 further comprising providing knowledge base for providing knowledge base data for use in at least one of said selecting said effect data, said selecting said causal data, and said analyzing.

14. The computer-implemented method of claim 8 further comprising providing external knowledge source for providing external knowledge data for use in at least one of said selecting said effect data, said selecting said causal data, and said analyzing.

15. A computer-implemented method for performing prediction from data generated from processing material processed in accordance with a process, comprising:
providing quality and material (Q&M) data representing process result for said material from said process:
providing manufacturing data representing manufacturing conditions present while said material is processed in accordance with said process;
selecting a prediction model from a knowledge base; and
generating said prediction using said prediction model, said Q&M data, and said manufacturing data.

16. The computer-implemented method of claim 15 wherein said Q&M data is clustered prior to said generating.

17. The computer-implemented method of claim 15 wherein said Q&M data is segmented prior to generating.

18. The computer-implemented method of claim 15 further including validating said prediction.

19. The computer-implemented method of claim 15 further comprising providing, knowledge base for providing knowledge base data for use in said generating.

20. The computer-implemented method of claim 15 further comprising providing external knowledge source for providing external knowledge data for use in at least one of said selecting and said generating.
